(19) United States
(12) Patent Application Publication
(10) Pub. No.: US 2008/0235913 A1
(43) Pub. Date: Oct. 2, 2008

(54) HANDLE

(76) Inventors: Roswitha Eicher, Filderstadt (DE); Stefan Heess, Leinfelden-Echterdingen (DE); Joerg Maute, Sindelfingen (DE); Florian Esenwein, Uhingen-Holzhausen (DE); Bernhard Eicher, Filderstadt (DE); Marcus Schuller, Dettenhausen (DE)

Correspondence Address: Striker, Striker & Stenby, 103 East Neck Road, Huntington, NY, 11743, US

(21) Appl. No.: 12/046,581

(22) Filed: Mar. 12, 2008

(30) Foreign Application Priority Data
Mar. 29, 2007 (DE) 102007015092.1
Dec. 10, 2007 (DE) 102007055735.5

(51) Int. Cl. B25G 1/01; B25D 17/04

(52) U.S. Cl. 16/430; 173/162.2

(57) ABSTRACT

A handle includes a grip element, a fastening element, and at least one damping element which is configured as a telescopic damping element, and can be used in a hand-held power tool.

### CROSS-REFERENCE TO A RELATED APPLICATION

The invention described and claimed hereinbelow is also described in German Patent Application DE 10 2007 015 092.1 filed on Mar. 29, 2007. This German Patent application, whose subject matter is incorporated here by reference, provides the basis for a claim of priority of invention under 35 U.S.C. 119(a)-(d).

### BACKGROUND OF THE INVENTION

The present invention relates to a handle, in particular an additional handle, for a hand-held power tool.

Numerous power tools, such as angle grinders, drills, and rotary hammers, are equipped with an extra handle. To prevent vibrations that occur during operation of the power tool from being transmitted to the operator via the additional handle, additional handles are often provided with vibration-dampening means.

Publication DE 10 2004 017 761 A1 makes known a vibration-damped handle that includes a rigid assembly part for detachable installation at one end of an electrical hand-held power tool, and that includes a grip part. The assembly part extends into the grip part, with vibration-damping means being provided between the grip part and the assembly part.

### SUMMARY OF THE INVENTION

The present invention is based on a handle that includes a grip element and a fastening element for detachably securing the handle to a housing of a hand-held power tool, and at least one damping element for damping vibrations during operation of the hand-held power tool.

According to the present invention, the handle includes a telescoping damping element as the damping element. The telescoping damping element will also be referred to below as the telescope damping element, for simplicity. The telescoping damping element effectively reduces vibrations that are transferred via the fastening element to the handle and, therefore, to the user, during operation of a hand-held power tool.

The telescoping damping element includes two or more telescoping elements, in particular, which are supported inside of each other in a telescoping manner. The design of the telescoping damping element is similar, in principle, to that of a hydraulic shock absorber, with the telescoping damping element including, in particular, at least one cylinder and a piston, which is displaceably supported in the cylinder. Within the framework of the present invention, the terms “cylinder” and “piston” mainly describe the function of these telescoping elements and in no way limit their geometric shape. For example, the cylinder and piston may be designed cylindrical in shape, although they may have a different cross-sectional shape.

In another embodiment, the telescoping damping element includes several cylinders that are connected in series, with two consecutive cylinders being connected by a displaceably supported piston. The damping effect of the telescoping damping element is increased by nesting several cylinders and pistons inside each other. Several series-connected cylinders and pistons result in improved vibration damping because they allow vibrations to be damped in a stepped manner.

The vibration damping is attained, in particular, by the fact that the piston is supported in the cylinder in a damping manner. The damping support is realized, in particular, using damping means located in the cavity of the cylinder. If vibrations occur, the damping means in the cylinder brake the motion of the piston in the cylinder. The damping support may be realized in a manner basically similar to a hydraulic shock absorber using a gas cushion or a liquid cushion.

The liquid may be, in particular, a relatively highly viscous fluid, e.g., an oil or a gel. As an alternative to the principle of a hydraulic shock absorber, the damping support may also be realized as a solid shock absorber, using an elastic element, in particular an elastomer, foam, or the like.

When several series-connected, telescoping elements with intermediate damping means are used, different damping means or similar damping means with different damping properties may also be used. Vibrations may therefore be reduced in the handle in a deliberate manner. If gas cushions are provided as the damping means, for example, every gas cushion between a piston and a cylinder may be provided with different gas pressure. As an alternative, different elastic elements, e.g., elastomers with different elasticity, may be used as the damping means.

In a special embodiment, the telescoping damping element may also be a hydraulic telescoping damping element. The telescoping damping element is composed, in a manner known per se, of a piston that is guided on a piston rod in a cylinder filled with a hydraulic fluid, e.g., oil. When the piston rod and cylinder move axially relative to each other, the hydraulic fluid flows through narrow channels, bores, valves, or the like, in the piston. As the piston speed increases, so does the flow resistance and, therefore, the damping effect.

The inventive telescoping damping element may be positioned axially in or on the handle, so that its damping effect takes place in the axial direction. It may also be positioned radially in the handle, thereby resulting in vibration damping in the radial direction. A combination of an axially oriented telescoping damping element and a radially oriented telescoping damping element is also possible.

If the telescoping damping element is positioned in the handle in the axial direction, a second damping element may be provided, thereby ensuring that the telescoping damping element is supported in a vibration-damping manner in the radial direction. For example, the cylinder in which the piston is located may be supported relative to a receptacle for the cylinder in a manner that damps vibrations radially in that elastic means, e.g., in the form of elastomeric material, are provided between the outer surface of the cylinder and the inner surface of the receptacle. In particular, e.g., an O ring made of an elastomeric material may be located around the cylinder. As an alternative, individual, nub-shaped elastic means may be provided, or rib-shaped elastic means may be provided that are oriented in the longitudinal direction between the cylinder and the receptacle.

The telescoping damping element may be located in different positions in the handle, and it may connect two elements of the handle, e.g., the fastening element and the grip element, with each other in different, vibration-damping manners. In one embodiment, the fastening element is supported relative to the grip element using the telescoping damping element, in a vibration-damping manner. The telescoping damping element may be positioned in the axial direction, so that the grip element is connected with the fastening element via the telescoping damping element in a vibration-damping manner. This may be realized in a specific embodiment in a manner such that the grip element is designed as a hollow grip sleeve. The grip sleeve may be supported in a vibration-damping manner relative to the fastening element using the telescoping damping element by the fact that the telescoping damping element extends inside the grip sleeve in the axial direction. To this end, the telescoping damping element includes a support on the fastening element and on the grip element. It may be integrally formed, e.g., on the fastening element and/or the grip element, but it may also be attached to the fastening element and/or the grip element in any other manner.

As an alternative, the telescoping damping element may be positioned in the radial direction, in order to support the fastening element in the radial direction and in a vibration-damping manner relative to the grip element. This may be realized, e.g., by designing the fastening element to extend into the grip element in the manner of a rod, and by providing at least one piston in the grip element on the fastening element, the piston being displaceable radially in a cylinder located on the grip element. Or, a cylinder may also be positioned radially on the fastening element, which extends into the grip element, and a piston may be positioned radially on the grip element.

In a further embodiment, the telescoping damping element may also be located in the handle such that the telescoping damping element is located in the housing after the handle is installed on a housing of a hand-held power tool. The telescoping damping element may be installed on the housing of the hand-held power tool, in which case the telescoping damping element includes a receptacle for the fastening element of the handle, e.g., a receptacle with an inner thread, thereby enabling a threaded fastening element to be screwed into the receptacle. Preferably, however, the telescoping damping element is connected with the fastening element, and, therefore, the handle. The fastening element includes a piston, which is displaceably supported in a cylinder. The cylinder is located in a receptacle, which may be provided, e.g., with an outer thread, so that the receptacle—including the telescoping damping element—may be screwed into the housing of a hand-held power tool. In this embodiment, therefore, the fastening element is supported relative to the housing of the hand-held power tool using the telescoping damping element, in a vibration-damping manner.

The grip element itself may also have a telescoping design. In this case, the grip element is composed, e.g., of a first partial element, which is the cylinder, and a second element, which is the piston. The grip element may also be composed of a large number of sub-elements, which are supported such that they are displaceable inside each other, in particular in a damping manner, as pistons and cylinders, in the form described above. If the grip element includes a grip sleeve, the grip sleeve itself may be composed of at least two sub-elements, in a similar manner.

In a further embodiment, the grip element includes a grip sleeve and a grip core, the grip sleeve being supported in a vibration-damping manner relative to the grip core using the telescoping damping element. The telescoping damping element is positioned, in particular, radially between the grip core and the grip sleeve.

The grip element of the inventive handle has a substantially cylindrical shape. In a simple embodiment, this may be a cylinder. The cylindrical grip element may also be adapted to the ergonomics of the human hand by providing it, e.g., with a different diameter along its longitudinal axis—in deviation from a purely cylindrical shape—, so that it therefore has a rounded shape. The grip element may be rotationally symmetrical, thereby enabling the user to grip the handle in any direction. As an alternative, the grip element may also be adapted to the ergonomics of the human hand in such a special manner that a first region of the grip element serves especially as a contact surface for the hand surface, and a second region serves as a contact surface for the fingers.

The grip element may also be designed as one piece or a multiple-component part. A multiple-component grip element is composed, e.g., of a grip core and a grip sleeve, optionally with damping means located between them. One or more parts of the grip element may also be vibration-damping in design. For example, the grip sleeve may be composed of an elastic material, e.g., an elastomer or a foam, or the grip core may be designed as an absorber mass. The grip element may also have a coating made of an elastic material.

The fastening element of the handle serves to detachably attach the handle to a housing of a hand-held power tool. In a simple embodiment, the fastening element may be a threaded bolt, a screw, or the like. The handle is therefore screwable into the housing of the hand-held power tool. Or, the fastening element may be a type of threaded bolt, or another type of a receptacle with an internal thread, with a corresponding thread being provided on the housing of the hand-held power tool for fastening the handle. Instead of a screw device, a clamping device may be provided as the fastening element, for example, for securing the handle.

The fastening element may be designed as one piece or a multiple-component part. A two-component fastening element is composed, e.g., of a fastening device and a carrier element. The fastening device may be, e.g., a screw device, e.g., a threaded bolt, a screw, or the like, or it may be a clamping device. The fastening device is located on the carrier element, e.g., in that a threaded bolt is covered with a plastic carrier element applied via injection moulding. The carrier element for the fastening device forms the head of the handle and faces the head of the handle when the handle is installed on the housing of a hand-held power tool.

The inventive handle is suited, in particular, for use as an additional handle for a cordless or mains-operated hand-held power tool, e.g., an angle grinder or a rotary hammer. A further subject of the present invention, therefore, is a hand-held power tool that includes an inventive handle.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a first exemplary embodiment of a handle with an axially positioned, telescoping damping element,

FIG. 2 shows a second exemplary embodiment of a handle with a radially positioned, telescoping damping element,

FIG. 3 shows a third embodiment of a handle with a telescoping damping element located between the grip element and the fastening element,

FIG. 4 shows a fourth embodiment of a handle with a telescoping grip element

FIG. 5 shows a fifth exemplary embodiment of a handle with an axially positioned, telescoping damping element in a housing of a hand-held power tool.

### DESCRIPTION OF THE PREFERRED EMBODIMENTS

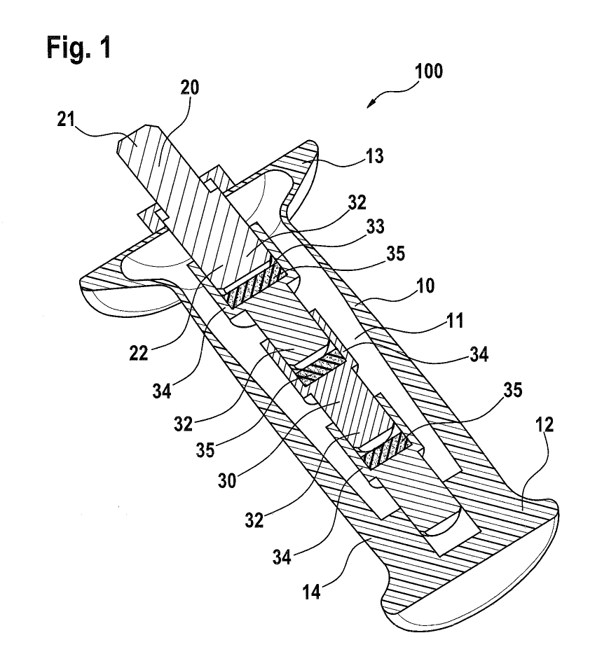

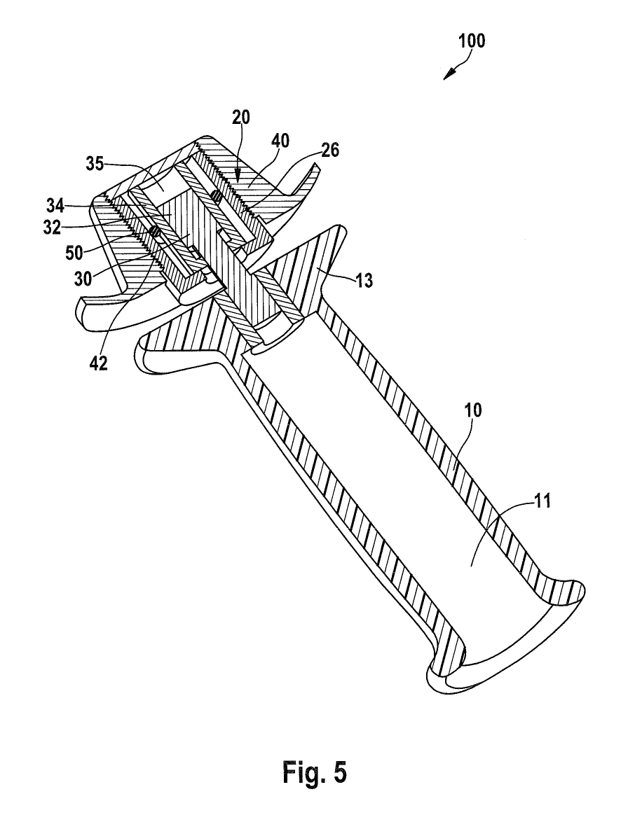

A handle 100 is shown schematically in FIG. 1, which is suited, in particular, for use as an additional handle for a hand-held power tool (a portion of which is shown in FIG. 5). It includes a grip element 10, which, in the embodiment shown, is designed hollow along its entire length. In FIG. 1, the cavity is labeled with reference numeral 11. Grip element 10 is provided with a collar-type expansion 13 at one end, which faces the hand-held power tool when it is installed on the hand-held power tool, and which serves to provide a secure grip. On this end of handle 100, a fastening element 20 extends out of grip element 10. Fastening element 20 serves to attach handle 100 to a housing 40 of a hand-held power tool. Fastening element 20 shown in FIG. 1 is, e.g., a threaded bolt, which is provided with a not-shown thread on its end 21 that extends out of grip element 10, for attaching handle 100 to housing 40. Handle 100 may therefore be screwed into the housing of a hand-held power tool. Instead of a thread, it is also possible to provide, e.g., a clamping device—as is already basically known from the related art—on free end 21. Opposite end 22 of fastening element 20 extends into grip element 10.

Fastening element 20 is supported in grip element 10 in a damping manner using a telescoping damping element 30. It is braced against grip element 10 via telescoping damping element 30. To this end, telescoping damping element 30 extends into cavity 11 in the axial direction along the grip element from end 22—which projects into grip element 10—of fastening element 20 to end 12 of grip element 10, which is opposite to fastening element 20. According to FIG. 1, telescoping damping element 30 includes several telescoping element in the form of pistons 32 and cylinders 34, which are supported inside each other in a telescoping manner. End 22 of fastening element 20 that projects into grip element 10 is designed as a first piston 32. First piston 32 is integrally formed on lower end 22 of fastening element 20. As an alternative, first piston 32 may also be attached to fastening element 20 in any other manner (not shown). First piston 32 is supported in a first cylinder 34 such that it is displaceable in the axial direction. The end of cylinder 34 that faces away from first piston 32 simultaneously forms a second piston 32, which, in turn, is supported in a second cylinder 34 such that it is displaceable and damping.

In a similar manner, a third piston 32 is formed on the end of second cylinder 34 facing away from second piston 32, which is accommodated in a third cylinder 34 in a similar manner. Finally, a further, fourth piston 32 is integrally formed on the end of third cylinder 34, which faces away from third piston 32. It is displaceably supported in a fourth cylinder 34. Fourth cylinder 34 is formed on lower end 12 of grip element 10, in that grip element 10 is provided with a recess on its lower end 12, which forms cavity 33 of cylinder 34. Pistons 32 are supported in cylinders 34 in a damping manner in that damping means 35 are provided in cavities 33 of cylinders 34. Damping means 35 may be a fluid cushion, e.g., a gas cushion or a fluid cushion. It may also be an elastic element, e.g., an elastomer or a foam. In FIG. 1, solid damping means 35, in particular made of an elastomer or foam, are depicted schematically between second piston 32 and second cylinder 34. When several pistons 32 and cylinders 34 are provided, similar or different damping means 35 may be used.

Accordingly, in the embodiment shown in FIG. 1, several cylinders 34 are connected in series, with two consecutive cylinders 34 being interconnected by a displaceably supported piston 32. Pistons 32 and cylinders 34 are supported inside each other in damping, telescoping manner.

As also shown in FIG. 1, to increase the stability of grip element 10, wall 14 of grip element 10 is designed with different thicknesses in the axial direction, with the wall thickness increasing toward lower end 12.

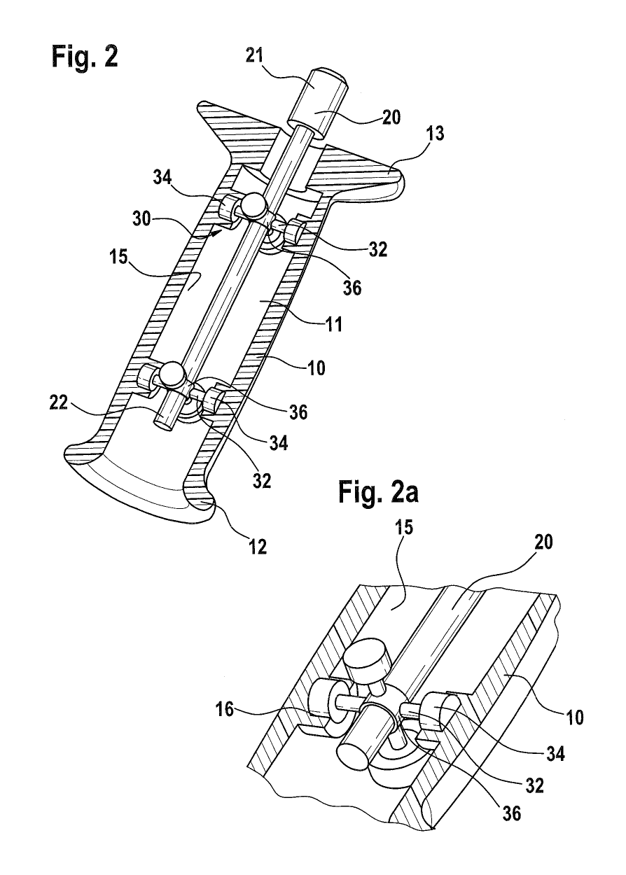

FIG. 2 shows a schematic illustration of an embodiment in which grip element 10 is also hollow in design, and fastening element 20 extends into cavity 11 of grip element 10 in the axial direction, in the manner of a rod. Fastening element 20 is supported relative to grip element 10 in a vibration-damping manner using two telescoping damping elements 30. Telescoping damping elements 30 are located between fastening element 20 and grip element in the radial direction. As shown in FIG. 2, a telescoping damping element 30 includes four pistons 32, which are positioned radially on fastening element 20, and four cylinders 34, which are positioned radially in the interior of grip element 10. Pistons 32 are displaceably supported in cylinders 34. Two pistons 32 and cylinders 34, in each case, are diametrically opposed to each other, so that the motion of pistons 32 in cylinders 34 may take place in a communicating manner. In a manner similar to the embodiment described in FIG. 1, pistons 32 are supported in a damping manner in cylinders 34 using damping means—which are not shown in FIG. 2—, such as gas, liquid or solid cushions.

In the enlarged section in FIG. 2a, it is shown that four pistons 32 are installed radially in a plane on fastening element 20 via a ball joint 36. Cylinders 34 are accommodated in recesses 16 in inner wall 15 of grip element 10.

The embodiment of a telescoping damping element shown in FIG. 2 may also be used with a handle that includes a grip element composed of a grip sleeve and a grip core that is coaxially supported in the grip sleeve. A telescoping damping element may also be located in the radial direction between the grip core and grip sleeve.

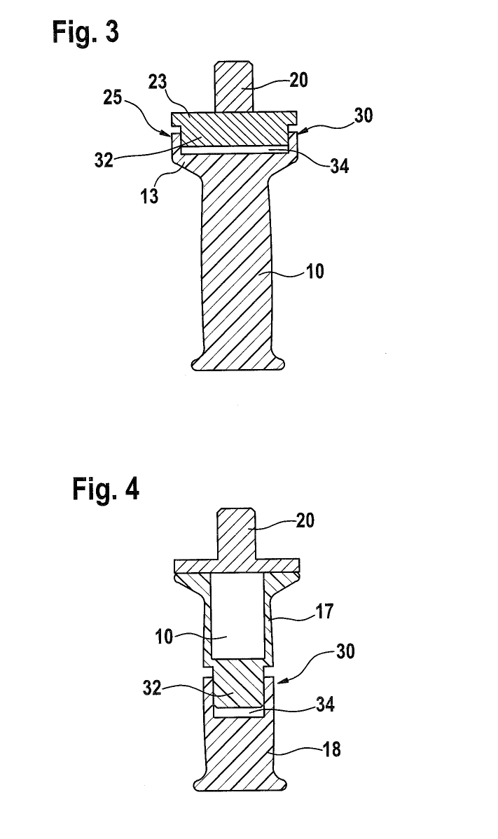

Further possible locations of telescoping damping element 30 for the vibration-damping support of one of the elements of handle 100 are shown schematically—for simplicity—in FIGS. 3 and 4. FIG. 3 shows a telescoping damping element 30 that is located axially between grip element 10 and fastening element 20 in head region 25 of handle 100. To this end, grip element 10 is provided with a collar 13, while fastening element 20 is equipped with a carrier element 23. Collar 13 and carrier element 23 form head region 25 of handle 100. A telescoping damping element 30 is provided between carrier element 23 and collar 13, the design of which includes at least one piston and a cylinder, and is not shown.

FIG. 4 is a schematic depiction of a design in which grip element 10 itself it telescoping. To this end, a first sub-element 17 of grip element 10 is designed as a piston 32 on its end facing away from fastening element 20, while a second sub-element 18 is designed as a cylinder 34 on its end facing fastening element 20. Piston 32 is supported in cylinder 34 such that it is displaceable and damping in the axial direction, so that both sub-elements 17, 18 of grip element 10 are guided inside each other in a telescoping manner. It is also possible to subdivide grip element 10 in to more than two sub-elements, the sub-elements—as cylinders and pistons—being displaceably supported inside each other (not shown).

A further embodiment an inventive handle with a telescoping damping element 30 is shown in FIG. 5. In this case, telescoping damping element 30 is located on handle 100 such that telescoping damping element 30 is located in housing 40 after handle 100 is installed on a housing 40 of a hand-held power tool. Only a section of housing 40 is shown, for simplicity. Telescoping damping element 30 is connected with fastening element 20. Telescoping damping element 30 is therefore part of handle 100. Piston 32 of telescoping damping element 30 is displaceably supported in cylinder 34 at one end, and it is fixedly supported in grip element 10 at the other end. In particular, cylinder 34 is filled with a gaseous damping means 35.

Cylinder 34 is located in a receptacle 26 provided with an outer thread. As a result, receptacle 26 of telescoping damping element 30 may be screwed into a receptacle 42 of housing 30 provided with an inner thread. Telescoping damping element 30 is positioned axially. A damping element 40 is also provided, in the form of an O ring made of an elastic material, e.g., an elastomer, which supports cylinder 34 in a vibration-damping manner in the radial direction. After handle 100 is installed on housing 40, receptacle 26, cylinder 34, and piston 32 of damping element 30 extend into housing 40.

It will be understood that each of the elements described above, or two or more together, may also find a useful application in other types of constructions differing from the type described above.

While the invention has been illustrated and described as embodied in a handle, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A handle, comprising a grip element; a fastening element; and at least one damping element, said damping element being configured as a telescoping damping element.

2. A handle as defined in claim 1, wherein said telescoping damping element includes at least one cylinder, and a piston which is displaceably supported in said cylinder.

3. A handle as defined in claim 1, wherein said telescoping damping element includes several series-connected cylinders, with two consecutive ones of said cylinders being connected by a displaceably supported piston.

4. A handle as defined in claims 2 or 3; and further comprising damping means for supporting said piston in said cylinder or in said two consecutive cylinders.

5. A handle as defined in claim 4, wherein said damping means is configured as an elastic element.

6. A handle as defined in claim 5, wherein said elastic element is an element composed of a material selected from the group consisting of an elastomere and a foam.

7. A handle as defined in claim 4, wherein said damping means is configured as means selected from the group consisting of a gas cushion and a liquid cushion.

8. A handle as defined in claim 1, wherein said telescoping damping element is positioned axially.

9. A handle as defined in claim 1; and further comprising a second damping element, said first mentioned telescoping damping element being supported in a vibration-damping manner in a radial direction using said second damping element.

10. A handle as defined in claim 1, wherein said telescoping damping element is positioned radially.

11. A handle as defined in claim 1, wherein said fastening element is supported relative to said grip element using said telescopic damping element in a vibration-damping manner.

12. A handle as defined in claim 1, wherein said handle is installable in a housing of a hand-held power tool, so that said telescopic damping element is locatable in said housing.

13. A hand-held power tool, comprising a handle including a grip element; a fastening element, and at least one damping element configured as a telescoping damping element.
